(19) United States
(12) Patent Application Publication
(10) Pub. No.: US 2011/0103955 A1
(43) Pub. Date: May 5, 2011

(54) CONICAL FRUSTUM WIND TURBINE

(76) Inventor: Jerry Desaulniers, Amherstburg (CA)

(21) Appl. No.: 12/610,305

(22) Filed: Oct. 31, 2009

(51) Int. Cl. F03D 1/06

(52) U.S. Cl. 416/183

(57) ABSTRACT

A self-funneling conical frustum wind turbine that has the widest end open and the smallest end and conical surfaces closed. The widest end turbine will automatically face into the wind causing a funneling effect of the wind into the center of the turbine. This turbine has a plurality of openings that are partially obstructed by optimally angled blades that cause rotational spin when the high pressure air exits the turbine. This turbine is connected to a centrally located shaft, and the centrally located shaft transfers the rotational energy from the shaft to an energy conversion device. A vertical support structure supports a horizontal pivot plane that includes a bearing. This allows the turbine assembly to rotate freely to automatically face the wind. This horizontal pivot plane supports the rotating turbine assembly.

### BACKGROUND OF THE INVENTION

1. Field of the Invention

This invention relates to wind-driven turbine. A wind turbine is a device that converts the force of the wind into rotary motion. This rotary motion is then used for direct mechanical energy or converted into another form of energy like electricity or heat.

2. General Background

For many years man has been using wind power, a renewable non-polluting source of energy. This source of energy has been used in the past in two major forms of energy extraction devices. One, being the vertical axis wind turbine and the other, the horizontal axis wind turbine.

The vertical axis wind turbines have a main rotating shaft that is perpendicular to the surface of the earth and tend to employ turbines with more surface area. This larger surface area can be a bonus as they can catch more of the wind's forces. However, some reverse friction occurs on the back side of the turbine on the return path. Many inventors have created clever devices that reduce this back side friction but these devices are complicated and might have tendencies to malfunction or produce extra noise.

The horizontal axis wind turbines have a main rotating shaft that is parallel to the surface of the earth and usually are placed on top of a tall vertical structure. These tall vertical structures can be expensive and the cost usually goes up incrementally with height. This is further complicated by the fact that most have to be serviced while remaining atop of these tall structures. Moreover, installation of these wind turbines requires a very large crane and many personnel to complete the installation. Previously, most horizontal axis wind turbines required a large tail to keep the turbine facing into the wind. This is because the turbine is upstream of the pivot point atop of the tower. In the present invention, the tail is totally unnecessary because the turbine is downstream of the pivot point and automatically faces into the wind.

Other problems commonly known with previous designs of horizontal axis wind turbines include poor efficiencies, and little to no power is produced at wind speeds below ten miles per hour. Some have recognized that funneling the wind could solve these problems. But previous attempts of mounting a wind funnel on a horizontal axis wind turbine included very complicated assemblies. These assemblies had to be close coupled to the turbine and had to simultaneously turn with the turbine into the wind. In this present invention, the funnel is part of the turbine. The funnel section of the turbine increases the force of the wind on the turbine blades on the inside of the conical frustum, where it crosses the turbine blades to the outside of the turbine. This outside surface of the conical frustum creates its own low pressure. This low pressure adds to the lift of the turbine blades by increasing the velocity of the fluid crossing the turbine blades. The net effect is a very efficient wind turbine that can operate in lower wind conditions. As well, it is robust and can be manufactured economically.

### DETAILED DESCRIPTION OF THE PREFERRED EMBODIMENTS

Referring to FIGS. 1 and 6, the present invention is a self-funneling conical frustum wind turbine system. A vertical support 1 which would normally be made out of a hard material like metal is used to support and anchor the system. Attached to the vertical support 1 is a bearing mechanism 2. The bearing mechanism 2 is a low friction device that allows the upper parts of the system to turn freely and to face into the wind. Fastened directly on top of the bearing mechanism 2 is a gearbox 3 and electrical generator 4 as shown in FIGS. 1 and 6. In this embodiment, the gearbox 3 transfers the rotational energy from a central shaft 5 at an increased rate of speed to an electrical generator 4. The electrical generator 4 could be replaced by an alternator or any other type of electrical generating device and the gearbox 3 may become unnecessary. As needs dictate, another type of energy conversion device may replace the gearbox 3 and the electrical generator 4. Some of the other rotational energy conversion devices currently available include fluid pumps, friction heaters, gas compressors or a line shaft perpendicular to the earth. But this present invention is not limited to these rotational energy conversion devices just mentioned. Therefore, any device that would replace the gearbox 3 and electrical generator 4 would sit atop the bearing mechanism 2 and would receive its rotational energy from the central shaft 5. The central shaft 5 could be made out of a hard material like metal, and would pass through two hubs. These hubs, the upwind hub 6 and the downwind hub 7 would be concentric and would be made out of a hard material. In this embodiment the upwind hub 6 would connect the turbine 12 to the central shaft 5 by using three or more spokes 11. The spokes preferably would be made out of a strong but light material. In this embodiment the downwind hub 7 would connect the turbine 12 to the central shaft 5. The upwind hub 6, the spokes 11, the downwind hub 7 and the central shaft 5 work together to support and strengthen the turbine 12. In this embodiment the turbine 12 has three members: a funnel ring 8, multiple turbine blades 9 and the frustum 10. These three members could be made out of strong but light materials like aluminum, fiberglass, plastic or carbon fibers. These 3 members could also be made up of a combination of different materials or molded or cast as a one-piece unit. Although currently this embodiment suggests using hard materials for the turbine 12, it could also be made out of a combination of flexible materials as long as there is a strong structure in place to support the members. This all depends on the size of the turbine and the availability of any new materials or manufacturing processes. In this embodiment a larger turbine 12 would have to be assembled in the field and this could change the manufacturing process. This is because most economical modes of transportation would only transport an eight-foot turbine 12 that was fully assembled. So in order to build larger turbines and remain cost-effective, they would have to be assembled in the field. This could limit the choices of preferred material for constructing a larger turbine.

The members of the turbine 12 have specific purposes. The funnel 8 collects the wind and increases the pressure of the air as it funnels it down and directs it to the turbine blades 9. Since the widest diameter of the funnel automatically faces into the wind, it will be perpendicular to the laminar flow of the wind. This means that the air that passes outside the lip of the funnel will be disturbed and become turbulent as it passes the widest section of the funnel 8 mouth. This action creates a low pressure on the outside of the conical frustum turbine. This low pressure helps to increase the velocity of the fluid passing through a turbine blade opening 15. This increases the usable rotational energy produced by the turbine 12.

The surface area of the funnel 8 mouth of the turbine 12 and the total surface area of the turbine blade openings 15 have an important ratio. Hereafter, this ratio will be referred to in terms of surface area of funnel mouth to total surface area of the turbine blade openings 15 where, when the funnel mouth has twice the surface area it would be called 2:1. When designing a wind turbine system for use in lower wind conditions, this ratio would range between 2:1 and 10:1. As this ratio increases, the air pressure on the inside of the turbine increases, and the usable energy at low wind speeds also increases. Also, as the pressure increases on the inside of the turbine 12, the core of the turbine 12 starts to become saturated to a point where it opposes the wind. Near this point of saturation, the turbine 12 is turning near top speed, and any increase in wind speed would increase the perpendicular force against the turbine 12. This increased force against the turbine 12 would translate into force against the other member of the system. Therefore, building a turbine with a higher ratio than 5:1 could become cost-prohibitive mainly because some of the members of the system would have to be fortified to withstand high wind conditions. Under circumstances where a very tall vertical support is used or where damaging winds are common, a ratio of less than 2:1 is preferred.

The turbine blades 9 partially cover the turbine blade openings 15 and are angled optimally to give the maximum rotational torque when the air passes through the turbine blade opening. These angled turbine blades 9 may also be twisted along their length for added torque. The frustum 10 is a closed surface and connects the downwind hub 7 to the turbine blades 9.

FIG. 2 shows another possible embodiment of this present invention. In FIG. 2, the small end of the conical frustum turbine is now partially open and employs three frustum support blades 13. These frustum support blades 13 are like aircraft propeller blades and connect the downwind hub 7 to the turbine 12. These frustum support blades 13 add rotational torque and structural support to the turbine 12. But this embodiment is not limited to three frustum support blades 13 and not limited to aircraft propeller style blades but may instead employ blades that are angled, or angled and twisted as frustum support blades 13.

Yet another embodiment of this present invention is displayed in FIG. 3. The turbine in this embodiment is the same as in FIG. 1 except a conical fluid guide 16 is added to the inside and rear of the turbine. This conical fluid guide 16 is a closed surface and is meant to direct the fluid towards the turbine blades. This conical fluid guide 16 should be made out of a hard and light material.

In yet another embodiment of this present invention, funnel support blades 14 shown in FIG. 4 are used instead of spokes 11 as shown in FIG. 3. These funnel support blades 14 perform the same functions as the spokes 11 except that they are shaped to increase rotational torque when the moving fluid passes over them.

In yet another embodiment of this present invention, the vertical support 1 in FIG. 1 is replaced with a tilt-up support mechanism. This tilt-up support mechanism is shown in FIGS. 5A and 5B. The energy-producing position is shown in 5A, and the maintenance position is shown in 5B. This tilt-up support mechanism is anchored to a steel reinforced concrete base 17. This concrete base 17 has steel cast into the concrete and this steel reinforcement connects a lower vertical support 23 member to a maintenance support 25 member. The lower vertical support 23 and the maintenance support 25 should be made out of steel. At the most vertical point of the lower vertical support 23 is a hinge 18. This hinge 18 should be strong enough to withstand the forces involved in supporting a wind turbine with a lot of surface area as described in this present invention. Above the hinge 18 is the upper vertical support 24. The upper vertical support 24 can be made out of steel, aluminum or another hard material. The upper vertical support 24 can have numerous lifting eyes attached to it. And these lifting eyes are to aid in cases where conventional rigging is employed or may be used for guy wires. A bearing mechanism 2 is attached to the top of the upper vertical support 24. This bearing mechanism 2 allows the turbine to turn freely to face the wind and is where the gearbox would normally be attached. When the upper vertical support 24 is raised to its full height, it will be fastened in a manner as to hold it against a vertical stop 19. This vertical stop 19 would be fastened or welded to the lower vertical support 23. FIG. 5B shows the turbine resting in the maintenance position. In this position, the upper vertical support 24 rests against a maintenance rest pad 22. This maintenance rest pad 22 is affixed to the maintenance support 25. In the maintenance position the upper vertical support 24 is approximately twenty degrees in relation to the earth. In the energy-producing position the vertical support member would be at ninety degrees or less in relation to the earth. Shown in FIG. 5A the upper vertical support is at 85 degrees in relation to the earth.

In order to raise the upper vertical support 24, a hydraulic cylinder 21 can be used. This hydraulic cylinder 21 would normally be removed after lifting the upper vertical support 24 to the energy producing position and the upper vertical support 24 would be affixed by heavy mechanical means. But where an automated system is preferred, the hydraulic cylinder 21 might stay in place. Then the upper vertical support 24 could be lower to the maintenance position by automatic means. This would be advantageous when extremely high winds occur. In the maintenance position, the turbine 12 is no longer perpendicular to the wind so the rotation of the turbine 12 decreases.

In yet another embodiment of this present invention, the vertical support 1 in FIG. 1 is replaced with a simple structure that attaches to the roof of a building. This rooftop structure is to be less than 6 feet tall and made out of strong materials.

### BRIEF DESCRIPTIONS OF THE DRAWINGS

FIG. 1 is a perspective side view of the wind turbine system as described in the preferred embodiment.

FIG. 2 is a perspective rear view of the turbine in another embodiment. This view shows the frustum end of the turbine partially open and displays the frustum support blades described in the embodiment.

FIG. 3 is a sectional side view of the turbine and rotating members of another embodiment of this present invention. In this embodiment, the conical fluid guide is shown.

FIG. 4 is a perspective side view of the turbine in another embodiment of this present invention. It displays the funnel support blades.

FIG. 5A is a side view of the wind turbine system in another embodiment of this present invention. Displayed is the upper vertical support in the energy-producing position.

FIG. 5B is a side view of the wind turbine system in another embodiment of this present invention. Displayed is the upper vertical support resting in the maintenance position.

FIG. 6 is a sectional side view of the turbine and rotating members in the preferred embodiment of this present invention.

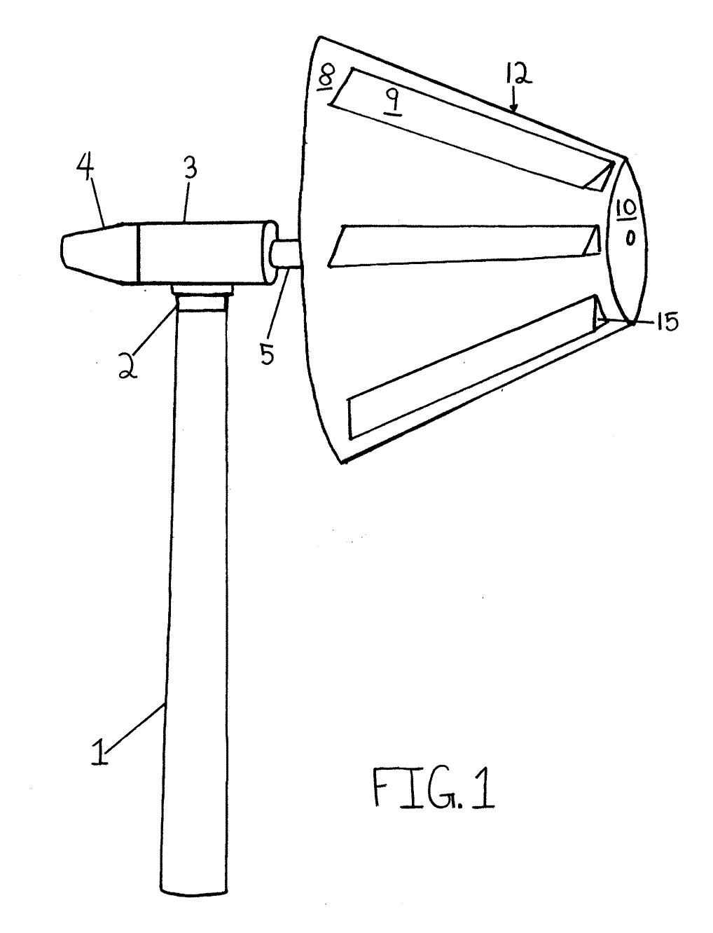

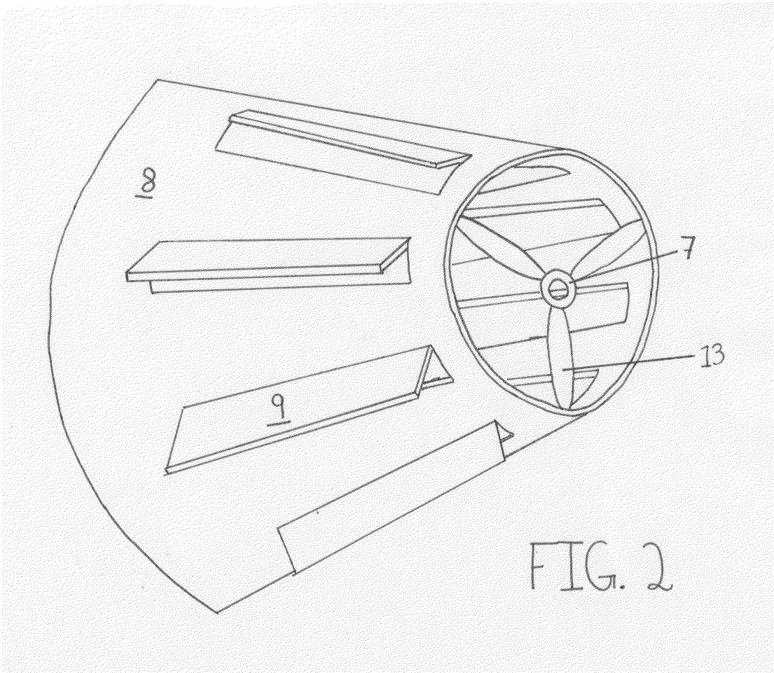

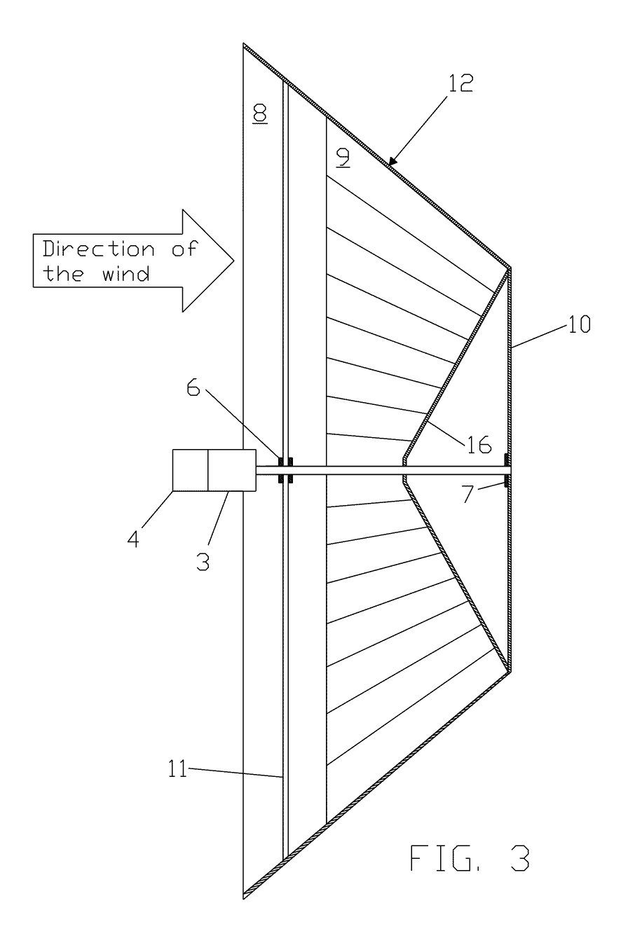

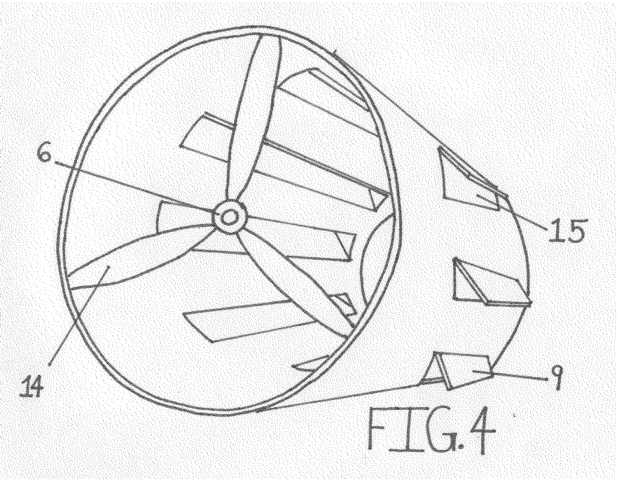

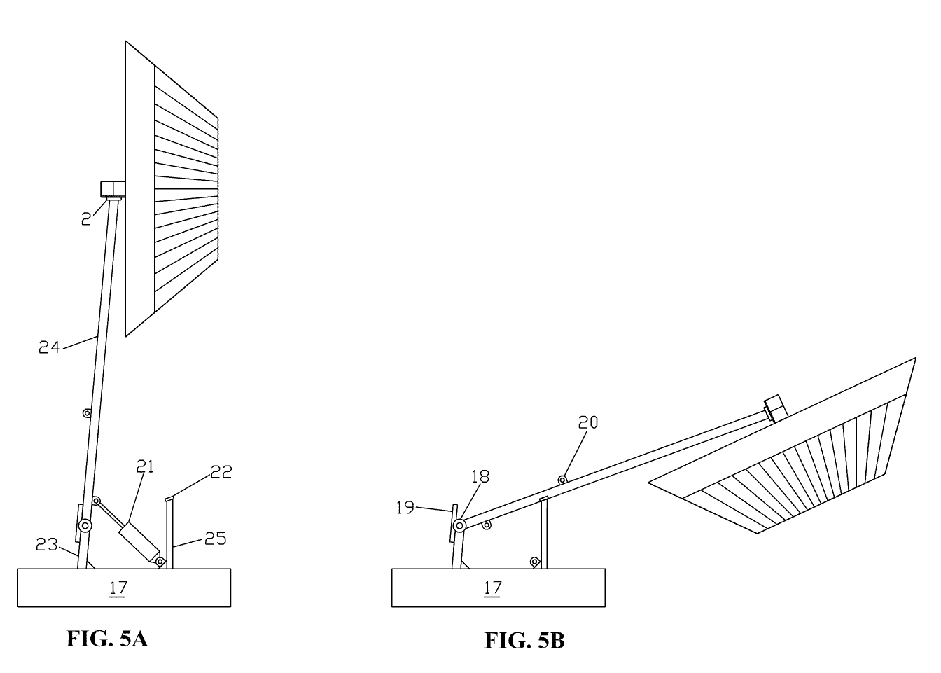

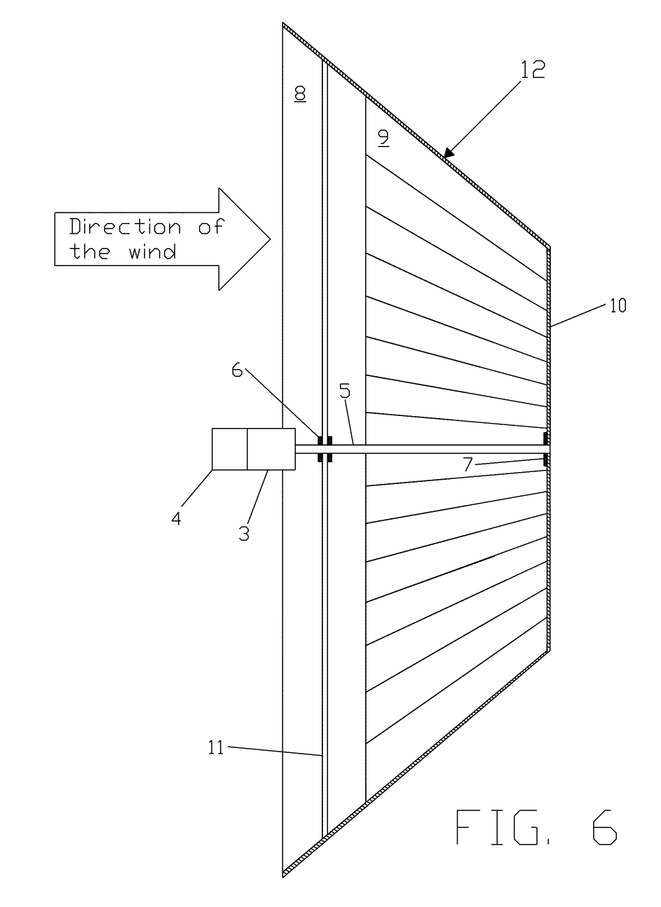

### SUMMARY OF THE PRESENT INVENTION

According to one embodiment of the present invention, there is a wind energy recovery system. This self-funneling conical frustum wind turbine converts the power of the wind into a clean renewable source of energy. This energy originates in the laminar flow of the wind, and is converted by the self-funneling conical frustum wind turbine. This is done when the leading edge of the integral funnel captures the wind and guides it into the core of the turbine. This raises the pressure in the core of the turbine and lowers the pressure of the air surrounding the turbine. This pressure differential causes the air to rapidly flow through the openings of the turbine. This fast moving air passes across angled blades and that gives the turbine rotational spin. The rotational spin transfers its energy to a central shaft that supports the turbine. This rotating central shaft now transfers the energy to an energy conversion device. This energy conversion device could be an electrical generator, a fluid compressor or any other energy conversion device capable of converting rotary energy. Normally, this energy conversion device can be mounted atop of a bearing mechanism. This bearing mechanism normally has a solid surface on the top that can rotate independently from the bottom section of the bearing mechanism. The top surface is where a means for supporting the shaft and allowing its rotation are affixed. This supporting mechanism can be a set of bearings, a gearbox or an energy conversion device. The bottom section of the bearing mechanism is connected to the support. According to one embodiment of this present invention, this support can be a fixed vertical support that anchors to the earth. But other embodiments may include a rooftop support or a retractable support.

I claim:

1. A self funneling conical frustum wind turbine system comprising:
A. a conical frustum turbine that has the widest end open and the smallest end and conical surfaces closed where the widest end of said conical frustum turbine will automatically face into the wind causing a funneling effect of the wind into the center of the said conical frustum turbine and said conical frustum turbine has a plurality of openings that are partially obstructed by optimally angled blades that cause rotational spin when the high pressure air exits the turbine:
B. a vertical support structure where a horizontal pivot plane is mounted at the top of said support structure and where a means for converting rotational energy to electricity or mechanical energy is attached to said horizontal pivot plane and a centrally located shaft is attached to said means for converting rotational energy and said centrally located shaft follows the pivot point automatically pointing downwind, and said centrally located shaft is attached to said conical frustum turbine.

2. The wind turbine system in claim 1 wherein said conical frustum turbine previously claimed the smaller end to be a closed surface would instead employ optimally angled blades to provide extra rotational lift and said optimally angled blades would connect said centrally located shaft to the small end of the conical frustum.

3. The wind turbine system in claim 1 wherein a conical shape deflector ring is placed in said conical frustum turbine to help direct the flow of air away from the central shaft and towards the openings that are partially obstructed by optimally angled blades.

4. The wind turbine system in claim 1 wherein a plurality of blades that are optimally angled along their length to provide directional lift and connect said conical frustum turbine to said centrally located shaft and provide structural strength.

5. The wind turbine system in claim 1 previously claimed a vertical support structure instead claims a tilt up vertical support wherein said tilt up vertical structure has a solid stop limiting it's tilt up to 90 degrees or less than 90 degrees in relation to the earths and said tilt up structure when lowered enables easy access to said truncated conical turbine for maintenance.

6. The wind turbine system in claim 1 previously claimed a vertical support structure instead claims a rooftop support structure wherein said rooftop structure is attached to the roof of a building and supports said horizontal pivot plane.
